(19) United States
(12) Patent Application Publication
(10) Pub. No.: US 2010/0039327 A1
(43) Pub. Date: Feb. 18, 2010

(54) DIGITAL TELEVISION ANTENNA

(76) Inventors: Chung-Wen YANG, Tu-Cheng City (TW); Yu-Yuan Wu, Tu-Cheng City (TW); Hung-Jen Chen, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/190,400

(22) Filed: Aug. 12, 2008

(51) Int. Cl. H01Q 1/38

(52) U.S. Cl. 343/700 MS

(57) ABSTRACT

A digital television antenna includes a ground plane, a first receiving portion, a second receiving portion, a linking portion, a first connecting strip, a longitudinal receiving strip, a second connecting strip, a feed-in portion and a coupling portion. The grounding plane, the longitudinal receiving strip, the first connecting strip, the first receiving portion, the linking portion, the second receiving portion, the second connecting strip and the feed-in portion compose a unit which can receive a frequency range between 470 and 650 MHZ wireless signal, and the coupling portion couples with the unit to receive a frequency range between 650 and 890 MHZ wireless signal. Therefore, the digital television antenna can receive the 474-858 MHZ range wireless signal which is used in the digital television field.

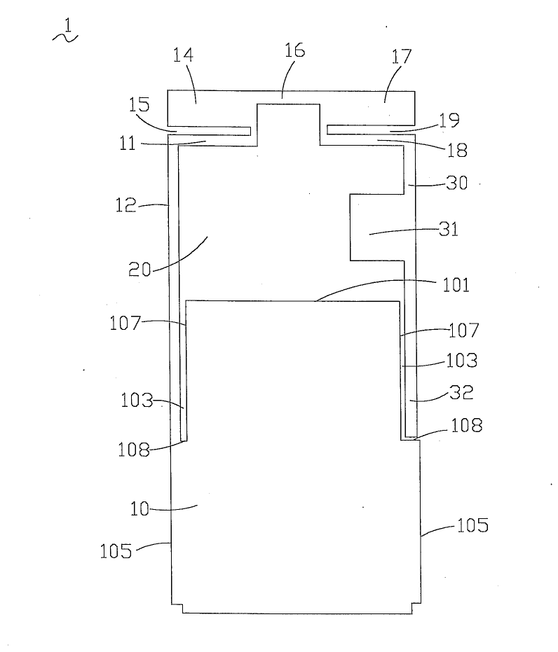

### BACKGROUND OF THE INVENTION

1. Field of the Invention

This present invention relates to an antenna, and more specifically to a digital television antenna.

2. The Related Art

Digital television replaces the cathode ray tube (CRT) television gradually. A digital television antenna as a part of the digital television is used to receive wireless signals.

A traditional digital television antenna has a narrow frequency range which can not suit the trend that the television channel increases constantly, for example, a digital television antenna disclosed in U.S. Pat. No. 7,151,491 has only a frequency range of 474-858 MHZ. Therefore, a digital television antenna having a wider frequency range is required.

### SUMMARY OF THE INVENTION

An object of the invention is to provide a digital television antenna including a grounding plane, a main receiving part, a first connecting strip, a longitudinal receiving strip, a second connecting strip, a feed-in portion and a coupling portion. The grounding plane defines a top edge. The main receiving part is located above the grounding plane to form a wider space therebetween. The main receiving part has a first receiving portion facing one side of the top edge, a second receiving portion facing the other side of the top edge and a linking portion located between and connecting the first receiving portion and the second receiving portion. The first connecting strip is located below the first receiving portion to define a first slot therebetween, the linking portion and the first receiving portion connect each other at ends thereof near the linking portion for sealing one end of the first slot. The longitudinal receiving strip extends downward from one end of the first connecting strip far from the linking portion to connect the grounding plane. The second connecting strip is located below the second receiving portion to define a second slot therebetween. The second connecting strip and the second receiving portion connect each other at ends thereof near the linking portion for sealing one end of the second slot. The feed-in portion extends downward from one end of the second connecting strip far from the linking portion and apart from the grounding plane. The coupling portion extends into the space from the feed-in portion and is spaced apart from the second connecting strip and the top edge.

Because the grounding plane, a main receiving part, a first connecting strip, a longitudinal receiving strip, a second connecting strip, a feed-in portion form an antenna portion similar to a loop antenna which can receive wireless signals in a predetermined frequency range, the coupling portion couples with the antenna portion to receive wireless signals in a frequency range different from that of the antenna portion. Therefore, the digital television antenna can receive wireless signals in a wider frequency range.

### BRIEF DESCRIPTION OF THE DRAWINGS

The invention, together with its objects and the advantages thereof may be best understood by reference to the following description taken in conjunction with the accompanying drawings, in which:

FIGURE is a perspective view of a digital television antenna according to the present invention.

### DETAILED DESCRIPTION OF THE PREFERRED EMBODIMENT

As shown in FIGURE, the present invention relates to a digital television antenna 1 for receiving digital television signals, more specifically digital terrestrial television signals. The digital television antenna 1 is made of a metallic sheet on a printed circuit board (PCB) in the embodiment.

The digital television antenna 1 includes a grounding plane 10 and a main receiving part. The main receiving part is located above the grounding plane 10 to define a wider space 20 therebetween. The grounding plane 10 showing a rectangular shape has two lateral sides 105 and a top edge 101, the lateral sides 105 are arranged in the two sides of the grounding plane 10 symmetrically, the top edge 101 is defined in the top of the grounding plane 10. The upper portions of the lateral sides 105 define two longitudinal gaps 103 symmetrically, and the longitudinal gaps 103 pass through the two ends of the top edge 101, a bottom of the longitudinal gap 103 has a bottom side 108, a side of the longitudinal gap 103 has a long side 107.

The main receiving part has a first receiving portion 14, a second receiving portion 17 and a linking portion 16. The first receiving portion 14 faces a left side of the top edge 101. The second receiving portion 17 faces a right side of the top edge 101. The linking portion 16 is located between and connects the first receiving portion 14 and the second receiving portion 17. A first connecting strip 11 is located below the first receiving portion 14, and a right end of the first connecting strip 11 connects with a right end of the first receiving portion 14, the first connecting strip 11 and the first receiving portion 14 define a first slot 15, a left end of the first slot 15 communicates outside, and a right end of the first slot 15 is sealed. A longitudinal receiving strip 12 extends downward from the left end of the first connecting strip 11, and a bottom end of the longitudinal receiving strip 12 is located in the corresponding longitudinal gap 103 and connects the bottom side 108 of the grounding plane 10, and the longitudinal receiving strip 12 is spaced with the long side 107 of the grounding plane 10. The left end of the first receiving portion 14, the left end of the first connecting strip 11 and a left end of the longitudinal receiving strip 12 are in a line. A second connecting strip 18 is located below the second receiving portion 17, and a left end of the second connecting strip 18 connects with a left end of the second receiving portion 17, the second connecting strip 18 and the second receiving portion 17 define a second slot 19, a right end of the first slot 19 communicates outside, and a left end of the first slot 19 is sealed. A feed-in portion 30 extends downward from the right end of the second connecting strip 18, and a bottom portion of the feed-in portion 30 is spaced with the bottom side 108 and the long side 107 positioned in the right side of the grounding plane 10. The right end of the second receiving portion 17, the right end of the second connecting strip 18 and a right end of the feed-in portion 30 are in a line. A coupling portion 31 extends from the inner side of the feed-in portion 30 into the wider space 20 and is spaced with the second connecting strip 18 and the top edge 101.

Either the distance between the first and second receiving portions 14, 17 and the grounding plane 10, the area of the coupling portion 31, and the distance between the coupling portion 31 and the grounding plane 10 can be adjusted to realize less Voltage Standing Wave Ratio (VSWR) and wider frequency range of the digital television antenna 1.

When the digital television antenna 1 receives digital television signals, the grounding plane 10, the longitudinal receiving strip 12, the first connecting strip 11, the first receiving portion 14, the linking portion 16, the second receiving portion 17, the second connecting strip 18 and the feed-in portion 30 composes a unit which can receive a wireless signal in frequency range between 470 MHZ and 650 MHZ, the coupling portion 31 couples with the unit to receive a wireless signal in frequency range between 650 and 890 MHZ. Therefore, the digital television antenna 1 can receive the wireless signal in frequency range between 474-858 MHZ which is used in the digital television field.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A digital television antenna comprising:
a grounding plane defining a top edge;
a main receiving part located above the grounding plane to form a space therebetween, the main receiving part facing the top edge and having a first receiving portion, a second receiving portion, and a linking portion located between and connecting the first receiving portion and the second receiving portion;
a first connecting strip located below the first receiving portion to define a first slot therebetween, one end of the first receiving portion adjacent to the linking portion extending to a corresponding end of the first connecting strip for sealing one end of the first slot;
a longitudinal receiving strip extending downward from the other one end of the first connecting strip far from the linking portion to connect the grounding plane;
a second connecting strip located below the second receiving portion to define a second slot therebetween, one end of the second receiving portion adjacent to the linking portion extending to a corresponding end of the second connecting strip for sealing one end of the second slot;
a feed-in portion extending downward from the other end of the second connecting strip far from the linking portion and spaced apart from the grounding plane; and
a coupling portion extending from the feed-in portion into the space and spaced apart from the second connecting strip and the top edge.

2. The digital television antenna as set forth in claim 1, wherein the grounding plane defines two longitudinal gaps passing through the top edge in two lateral sides thereof, each of the gaps has a bottom side and a long side, a lower portion of the longitudinal receiving strip is located in the corresponding longitudinal gap and connects to the bottom side and apart from the long side, a lower portion of the feed-in portion is located in the corresponding gap and apart from the long side and the bottom side of the corresponding gap.

3. The digital television antenna as set forth in claim 1, wherein the digital television antenna is made of a metallic sheet in a printed circuit board.
